(19) United States
(12) Patent Application Publication
(10) Pub. No.: US 2026/0194634 A1
(43) Pub. Date: Jul. 9, 2026

(54) MEASUREMENT JIG AND THREE-DIMENSIONAL MEASUREMENT SYSTEM INCLUDING SAME

(71) Applicant: KAWASAKI JUKOGYO KABUSHIKI KAISHA, Kobe-shi, Hyogo (JP)

(72) Inventors: Shingo YONEMOTO, Kobe-shi (JP); Akitsugu ARAO, Kobe-shi (JP); Atsushi KYOTANI, Kobe-shi (JP)

(21) Appl. No.: 19/132,332

(22) PCT Filed: Oct. 24, 2023
(86) PCT No.: PCT/JP2023/038381

§ 371 Date: May 22, 2025

(30) Foreign Application Priority Data
Nov. 29, 2022 (JP) 2022-190693

(51) Int. Cl. G01S 7/481; G01S 17/42

(52) U.S. Cl. CPC G01S 7/4817; G01S 7/4813; G01S 17/42

(57) ABSTRACT

This measurement jig is a measurement jig that reflects laser light emitted from a three-dimensional measurement device and includes: a pedestal to be placed at a measurement point; a holder provided on the pedestal in a manner to be tiltable about the measurement point as a tilt fulcrum; and a reflector that is held by the holder and reflects the laser light emitted. The holder includes a sliding member that slides on the pedestal. The sliding member remains centered at the tilt fulcrum when sliding on the pedestal.

### TECHNICAL FIELD

The present disclosure relates to a measurement jig that reflects laser light emitted from a three-dimensional measurement device and also relates to a three-dimensional measurement system including the measurement jig.

### BACKGROUND ART

A three-dimensional measurement system is used for measuring a three-dimensional position of a measurement point located on a measurement subject. For example, the laser tracker system disclosed in Patent Literature (PTL) 1 is known as one example of the three-dimensional measurement system. In the laser tracker system disclosed in PTL 1, a laser tracker emits laser light to a reflector on a probe having a tip in contact with a measurement point. The laser tracker receives the laser light reflected by the reflector and thereby calculates the center position of the reflector. In the laser tracker system, the probe is rotated or tilted in various directions about the measurement point as a fulcrum to move the reflector. The laser tracker calculates the center position of the reflector at more than one location. The laser tracker calculates the position of the measurement position on the basis of the plurality of center positions calculated.

### CITATION LIST

### Patent Literature

PTL 1: Japanese Laid-Open patent Application Publication (Japanese Translation of PCT Publication) No. 2015-510115

### SUMMARY OF INVENTION

### Technical Problem

With the laser tracker system disclosed in PTL 1, it is possible to measure the position of a measurement point more accurately as a measurement range in which the center position of the reflector can be measured becomes wider. Therefore, the probe is preferably tilted at a larger angle. However, in the laser tracker system disclosed in PTL 1, the probe is sharp at the tip. For this reason, the tip of the probe may become misaligned with the measurement point if the probe is tilted at a large angle, meaning that the probe cannot be tilted at a larger angle. As a result, the measurement range in which the center position of the reflector can be calculated is narrow, causing a decrease in the accuracy of measuring the three-dimensional position of a measurement point.

In view of this, the present disclosure has an object to provide a measurement jig capable of improving the accuracy of measuring the three-dimensional position of a measurement point and also provide a three-dimensional measurement system including the measurement jig.

### Solution to Problem

A measurement jig according to the present disclosure is a measurement jig that reflects laser light emitted from a three-dimensional measurement device and includes: a pedestal to be placed at a measurement point; a holder provided on the pedestal in a manner to be tiltable about the measurement point as a tilt fulcrum; and a reflector that is held by the holder and reflects the laser light emitted. The holder includes a sliding member that slides on the pedestal. The sliding member remains centered at the tilt fulcrum when sliding on the pedestal.

According to the present disclosure, the holder includes the sliding member that slides on the pedestal while remaining centered at the tilt fulcrum. Therefore, when tilting the holder, the tilt fulcrum for the holder is kept from becoming misaligned with the measurement point, and the holder can be tilted at a larger angle. Thus, it is possible to improve the accuracy of measuring the three-dimensional position of the measurement point.

A three-dimensional measurement system according to the present disclosure includes: the above-described measurement jig; and the three-dimensional measurement device that emits laser light and measures a three-dimensional position of the measurement point on the basis of the laser light reflected by the measurement jig.

According to the present disclosure, a support member expands and contracts in a predetermined direction. Therefore, it is possible to move the reflector toward and away from the pedestal. Thus, when the laser light is blocked by a measurement subject, other obstacles, or the like, it is possible to cause the support member to expand and contract to move the reflector to a zone where the laser light reaches. This reduces the need to move the three-dimensional measurement device 3 during measurement.

### Advantageous Effects of Invention

According to the present disclosure, it is possible to improve the accuracy of measuring the three-dimensional position of a measurement point.

The above object, other objects, features, and advantages of the present disclosure will be made clear by the following detailed explanation of preferred embodiments with reference to the attached drawings.

### BRIEF DESCRIPTION OF DRAWINGS

FIG. 1 is a perspective view illustrating a three-dimensional measurement system according to Embodiment 1 of the present disclosure.

FIG. 2 is a perspective view illustrating a measurement jig included in the three-dimensional measurement system illustrated in FIG. 1.

FIG. 3 is a perspective view illustrating a pedestal included in the measurement jig illustrated in FIG. 2.

FIG. 4 is a perspective view illustrating a support member of a holder included in the measurement jig illustrated in FIG. 2.

FIG. 5 is a perspective view illustrating a reflector and a holding member of a holder included in the measurement jig illustrated in FIG. 2.

FIG. 6 is a side view illustrating the measurement jig illustrated in FIG. 2 with a support member expanded.

FIG. 7 is a side view illustrating the measurement jig illustrated in FIG. 2 that has been tilted.

FIG. 8 is a diagram showing a reflector measurement range in which the measurement by the measurement jig illustrated in FIG. 2 is possible.

FIG. 9 is a perspective view illustrating a measurement jig included in a three-dimensional measurement system according to Embodiment 2 of the present disclosure.

FIG. 10 is a perspective view illustrating a reflector and a holding member of a holder included in the measurement jig illustrated in FIG. 9.

FIG. 11 is a perspective view illustrating a measurement jig included in a three-dimensional measurement system according to another embodiment of the present disclosure.

### DESCRIPTION OF EMBODIMENTS

Hereinafter, three-dimensional measurement systems 1, 1A according to Embodiments 1, 2 of the present disclosure and measurement jigs 2, 2A included therein will be described with reference to the aforementioned drawings. Note that the concept of directions mentioned in the following description is used for the sake of explanation; the orientations, etc., of elements according to the invention are not limited to these directions. Each of the three-dimensional measurement systems 1, 1A and the measurement jigs 2, 2A described below is merely one embodiment of the present disclosure. Thus, the present disclosure is not limited to the embodiments and may be subject to addition, deletion, and alteration within the scope of the essence of the invention.

### Embodiment 1

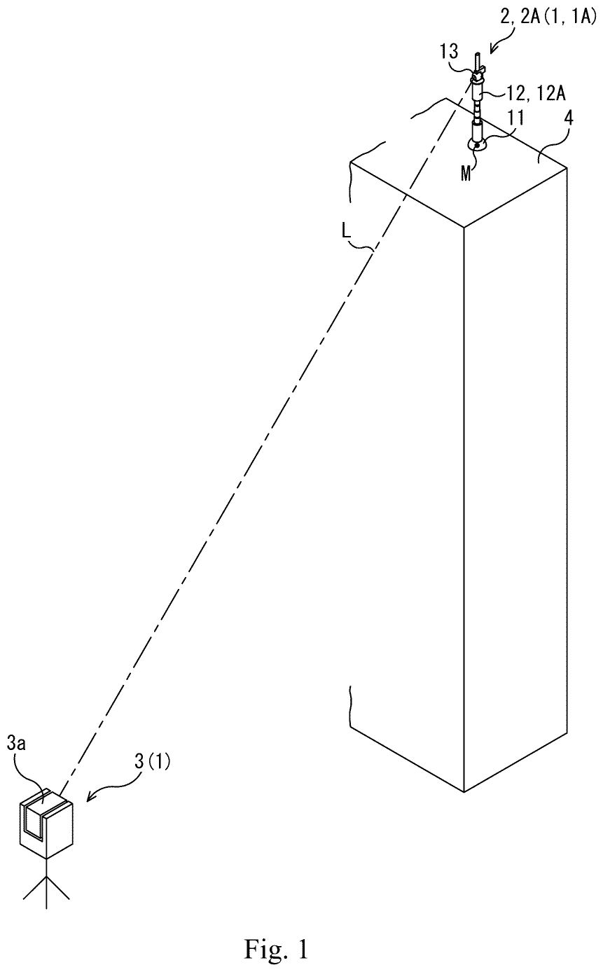

The three-dimensional measurement system 1 according to Embodiment 1 illustrated in FIG. 1 measures the three-dimensional position (hereinafter referred to simply as “the position”) of a measurement point M on a measurement subject 4 by using laser light L. The three-dimensional measurement system 1 includes a three-dimensional measurement device 3 and a measurement jig 2.

### <Three-Dimensional Measurement Device>

The three-dimensional measurement device 3 measures the position of the measurement point M by emitting laser light L and receiving reflected laser light L. More specifically, the three-dimensional measurement device 3 includes a measurement part 3a that emits and receives the laser light L. The three-dimensional measurement device 3 causes the measurement part 3a to rotate left and right and up and down. The three-dimensional measurement device 3 is FRRO Vantage (registered trademark), for example. Note that the three-dimensional measurement device 3 is not limited to FRRO Vantage (registered trademark) and may be a measurement device including said function (for example, AT960 and ATS600 manufactured by Leica Camera AG and RadianPro manufactured by API). The three-dimensional measurement device 3 measures the position of the measurement point M in coordination with the measurement jig 2. More specifically, the three-dimensional measurement device 3 emits the laser light L to the measurement jig 2. Subsequently, the three-dimensional measurement device 3 calculates the position of the measurement point M by receiving reflected light from the measurement jig 2, which will be described in detail later.

### <Measurement Jig>

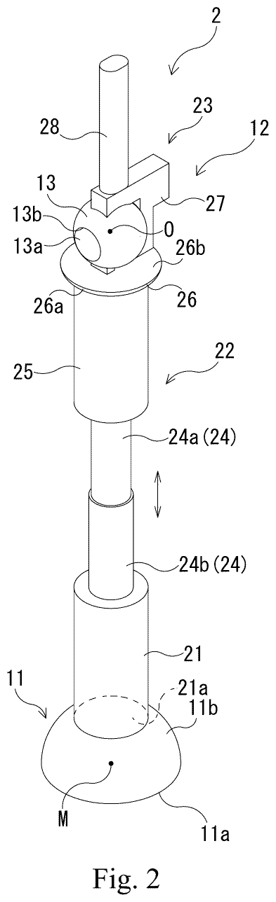

As illustrated in FIG. 2, the measurement jig 2 is placed at the measurement point M. The measurement jig 2 reflects the laser light L emitted from the three-dimensional measurement device 3. The measurement jig 2 brings the reflected laser light, i.e., the reflected light, back to the three-dimensional measurement device 3. The measurement jig 2 includes a pedestal 11, a holder 12, and a reflector 13.

### <Pedestal>

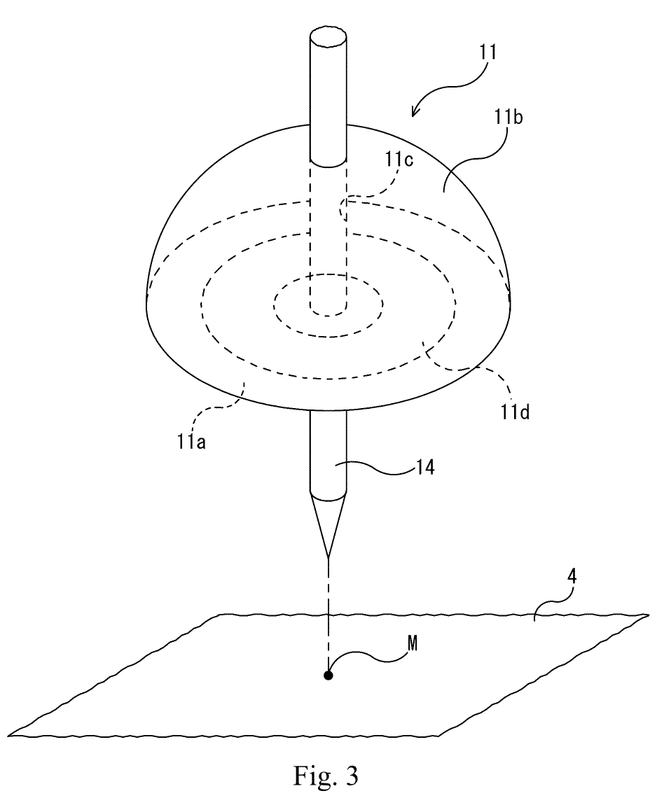

As illustrated in FIG. 3, the pedestal 11 is placed at the measurement point M. The pedestal 11 slidably supports the holder 12 to be described in detail later. The pedestal 11 includes a mounting surface 11a and a bearing surface 11b. The mounting surface 11a is formed flat and forms the lower surface of the pedestal 11. With the mounting surface 11a facing the measurement subject 4, the pedestal 11 is mounted on the measurement subject 4. The bearing surface 11b is formed in the shape of a partial sphere and forms the upper surface of the pedestal 11. It is possible to align the center (tilt fulcrum) of the bearing surface 11b with the measurement point M when placing the pedestal 11 at the measurement point M. More specifically, the bearing surface 11b is formed so that the center thereof is located on a virtual plane including the mounting surface 11a. In the present embodiment, the bearing surface 11b is formed as a hemispherical surface. This means that the pedestal 11 is formed in the shape of a hemisphere. The pedestal 11 is formed so that the center of the hemisphere, that is, the center of the pedestal 11, is located on a virtual plane including the mounting surface 11a.

The pedestal 11 includes a through-hole 11c and a suction part 11d. The through-hole 11c extends through the pedestal 11 so as to pass through the tilt fulcrum in the pedestal 11. More specifically, the through-hole 11c is formed so that the axial line thereof passes through the tilt fulcrum and extends perpendicular to the mounting surface 11a. Furthermore, a pointing member 14 can be inserted through the through-hole 11c. Here, the pointing member 14 is a member that is brought into contact with the measurement point M and points the measurement point M. In the present embodiment, the pointing member 14 is a rod-shaped member that can be inserted through the through-hole 11c and is sharp at the tip. The through-hole 11c can align the center (that is, the tilt fulcrum) of the pedestal 11 with the measurement point M when the pedestal 11 is mounted on the measurement subject 4 so that the tip of the pointing member 14 is in contact with the measurement point M.

The suction part 11d can be attached to and detached from a portion around the measurement point M. In the present embodiment, the suction part 11d is a permanent magnet. Note that the suction part 11d may be an electromagnet, a suction cap, or the like; it is sufficient that the suction part 11d be configured to allow the attachment and detachment thereof to and from the measurement subject 4. The suction part 11d is attached to the mounting surface 11a of the pedestal 11, for example. The suction part 11d adheres to a portion of the metallic measurement subject 4 that is located around the measurement point M. Thus, the pedestal 11 is attached to a portion of the measurement subject 4 that is located around the measurement point M.

### <Holder>

As illustrated in FIG. 2, the holder 12 is provided on the pedestal 11. More specifically, the holder 12 is placed on the bearing surface 11b of the pedestal 11 and slidably supported by the pedestal 11. The holder 12 extends in a predetermined direction. The holder 12 expands and contracts in the predetermined direction. The holder 12 including such functions includes a sliding member 21, a support member 22, and a holding member 23.

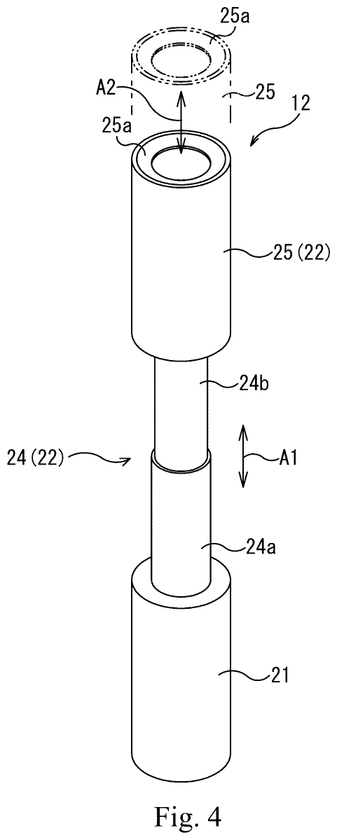

As illustrated in FIG. 4, the sliding member 21 slides on the pedestal 11. The sliding member 21 is formed in the shape of a circular column extending in the predetermined direction, for example. Note that the shape of the sliding member 21 may be a polygonal prism, a cube, or the like, and is not limited to a circular column. The sliding member 21 includes a concave surface 21a at one end in the predetermined direction. The concave surface 21a is a surface depressed on the other side in the predetermined direction. More specifically, the concave surface 21a is formed in the shape of a partial sphere depressed on the other side in the predetermined direction. The concave surface 21a has curvature equal to the curvature of the bearing surface 11b. The concave surface 21a is in slidable contact with the bearing surface 11b. Therefore, the sliding member 21 slides on the pedestal 11 (or the bearing surface 11b) while remaining centered at the tilt fulcrum. Note that the sliding member 21 is formed so as to contact the bearing surface 11b at three points.

The support member 22 is a member extending in the predetermined direction. The support member 22 is provided on the sliding member 21. More specifically, the sliding member 21 is provided at a portion of the support member 22 that is located at one end in the predetermined direction. The support member 22 is provided on the pedestal 11 via the sliding member 21. Thus, the support member 22 is tilted while remaining centered at the tilt fulcrum. Furthermore, the support member 22 can expand and contract in the predetermined direction. The support member 22 slidably supports the holding member 23, which will be described in detail later, at the other end in the predetermined direction. The support member 22 configured as just described includes a contraction part 24 and a support part 25.

The contraction part 24 extends in the predetermined direction. The sliding member 21 is provided at a portion of the contraction part 24 that is located at one end in the predetermined direction. The contraction part 24 is configured so as to be able to contract in the predetermined direction. More specifically, the contraction part 24 includes a large-diameter portion 24a and a small-diameter portion 24b which are cylindrical. The small-diameter portion 24b is inserted into the large-diameter portion 24a so as to be able to move back and forth. The contraction part 24 contracts by moving the small-diameter portion 24b back and forth with respect to the large-diameter portion 24a. Furthermore, the contraction part 24 remains in an expanded or contracted state when the small-diameter portion 24b is fixed to the large-diameter portion 24a by a fixing part not illustrated in the drawings. Note that said configuration of the contraction part 24 is merely one example; the contraction part 24 may have a different configuration as long as the contraction part 24 can expand and contract.

The support part 25 is provided at a portion of the contraction part 24 that is located at the other end in the predetermined direction. The support part 25 slidably supports the holding member 23 to be described in detail later. The support part 25 is formed in the shape of a circular column extending in the predetermined direction, for example. The support part 25 is provided at a portion of the contraction part 24 that is located at one end in the predetermined direction. Furthermore, the support part 25 includes a receiving seat 25a at the other end in the predetermined direction. The receiving seat 25a is a seat depressed on one side in the predetermined direction. More specifically, the receiving seat 25a is formed in the shape of a partial sphere depressed on one side in the predetermined direction. In the present embodiment, the receiving seat 25a is formed in the shape of a spherical zone. Note that the receiving seat 25a may be formed in the shape of a spherical cap.

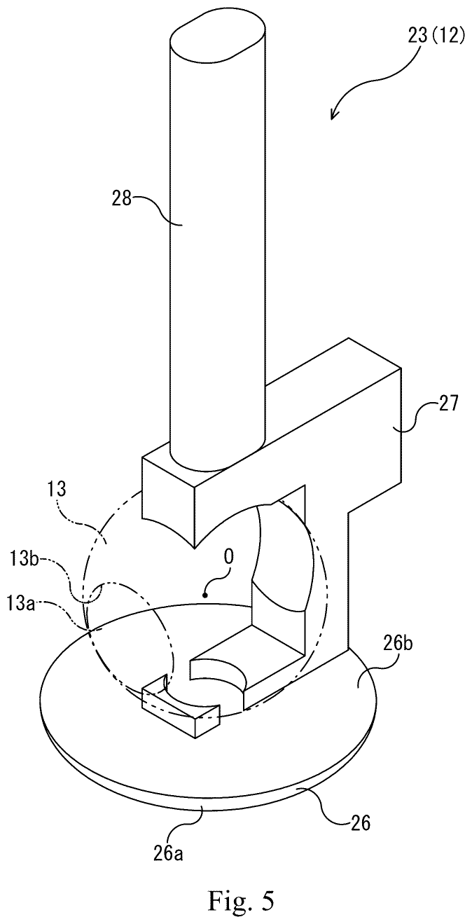

As illustrated in FIG. 5, the holding member 23 holds the reflector 13 to be described in detail later. The holding member 23 is provided on the support member 22 in a manner to be rotatable about a predetermined center of rotation. Here, the center of rotation is the center of the reflector 13 held by the holding member 23. The holding member 23 includes a sliding contact part 26, a holding part 27, and a grip part 28.

The sliding contact part 26 is slidably supported on the support part 25 of the support member 22. The sliding contact part 26 includes a sliding contact surface 26a and an attachment surface 26b. The sliding contact surface 26a, which is a surface of the sliding contact part 26 that is located on one side in the predetermined direction, is formed in the shape of a partial sphere (for example, in the shape of a spherical cap). The sliding contact surface 26a is formed in the shape of a partial sphere centered at the center of rotation. The sliding contact surface 26a has curvature equal to the curvature of the receiving seat 25a. Therefore, the sliding contact part 26 rotates about the center of rotation while sliding on the receiving seat 25a. The attachment surface 26b, which is a surface located on the other side in the predetermined direction, is formed flat.

The holding part 27 holds the reflector 13 to be described in detail later. The holding part 27 is mounted on the attachment surface 26b. The holding part 27 is formed in the shape of the letter “C” when viewed from the side (that is, when viewed perpendicularly to the predetermined direction). Therefore, the holding part 27 is open on one side in the first direction when viewed from the side. Note that the first direction is a direction perpendicular to a direction that is the thickness direction of the sliding contact part 26 and corresponds to the height direction of the holding part 27. The reflector 13 can fit into the holding part 27.

More specifically, the inner peripheral surface of the holding part 27 is recessed to match the shape of the reflector 13. In the present embodiment, the reflector 13 is formed in the shape of a sphere as will be described later. Therefore, a portion of the inner peripheral surface of the holding part 27 that is located on one side in the height direction (that is, on the attachment surface 26b side) is cut out in the shape of a circle when viewed in plan so that the reflector 13, which is in the shape of a sphere, can be placed thereon. Furthermore, the other portions of the inner peripheral surface of the holding part 27 are partially recessed in the shape of a partial sphere to match the shape of the outer surface of the reflector 13, which is in the shape of a sphere. Thus, the reflector 13 can fit into the holding part 27 (more specifically, into the space surrounded by the inner peripheral surface of the holding part 27). As a result of the fitting, the holding part 27 is supported on the three sides. Thus, the holding part 27 holds the reflector 13. Furthermore, when the reflector 13 fits into the holding part 27, the holding part 27 holds the reflector 13 positioned at a predetermined position. Here, the predetermined position is a position at which the center of the reflector 13 matches the center of rotation. Therefore, when the holding member 23 slides on the support member 22 (more specifically, the support part 25), the reflector 13 can rotate about the center thereof.

The grip part 28 is provided on the holding part 27. More specifically, the grip part 28 extends in the height direction so as to be away from the holding part 27. The grip part 28 is formed in the shape of a rod in the present embodiment. Note that the grip part 28 is not necessarily limited to being in the shape of a rod and may be in the shape of the inverted letter “U” or the like. The grip part 28 is formed so as to be grippable. The grip part 28 is gripped, for example, by a jig operator. A jig operator can slide the holding member 23 on the receiving seat 25a of the support member 22 while pressing the holding member 23 against the receiving seat 25a by the grip part 28.

### <Reflector>

As illustrated in FIG. 2 and FIG. 5, the holder 12 holds the reflector 13 as mentioned above. More specifically, the reflector 13 fits into the holding member 23 and is thus held by the holder 12. The reflector 13 reflects the laser light L emitted thereto. More specifically, the reflector 13 has retroreflective properties. Specifically, when the laser light L from the three-dimensional measurement device 3 enters the reflector 13, the reflector 13 reflects the laser light L in a direction parallel to and opposite to the incident direction. Thus, the reflector 13 can bring the emitted laser light L back to the three-dimensional measurement device 3.

More specifically, the reflector 13 is in the shape of a sphere. The reflector 13 includes a lens 13a therein. The lens 13a is exposed to the outside through an opening 13b formed in the outer surface of the reflector 13. The reflector 13 retro-reflects the laser light L incident on the lens 13a. With the opening 13b facing one side in the first direction, for example, the reflector 13 is held by the holder 12. In the state of being held by the holder 12, the reflector 13 can rotate about the center of the reflector 13 with respect to the holder 12. Thus, the reflector 13 can change the orientation of the opening 13b in the holder 12.

### <Mounting of Measurement Jig>

In the three-dimensional measurement system 1, the measurement jig 2 is mounted at the measurement point M located on the measurement subject 4 in the following method. This means that the pedestal 11 is placed at the measurement point M. More specifically, the pointing member 14 is inserted through the through-hole 11c of the pedestal 11 as illustrated in FIG. 3. The pointing member 14 is stuck into the measurement subject 4 so that the tip of the pointing member 14 protruding from the mounting surface 11a is aligned with the measurement point M. Subsequently, the pedestal 11 is brought closer to the measurement subject 4 along the pointing member 14, and the mounting surface 11a of the pedestal 11 eventually abuts the measurement subject 4. Thus, the pedestal 11 is placed on the measurement subject 4 so that the center, i.e., the tilt fulcrum, of the pedestal 11 matches the measurement point M. At this time, the suction part 11d adheres to a portion around the measurement point M. Thus, the pedestal 11 is fixed to a portion around the measurement point M so that the measurement point M matches the tilt fulcrum.

Meanwhile, the reflector 13 is attached to the holder 12, as illustrated in FIG. 2. More specifically, in the holder 12, the reflector 13 fits into the holding part 27 of the holding member 23. Thus, the holding member 23 holds the reflector 13. At this time, the reflector 13 is placed so that, for example, the opening 13b faces one side in the first direction. Note that the orientation of the opening 13b of the reflector 13 is not limited to one side in the first direction and may be another direction (for example, a direction at an angle on one or the other side in the height direction with respect to one side in the first direction).

Furthermore, in the measurement jig 2, the holder 12 is placed on the pedestal 11, as illustrated in FIG. 2. More specifically, with the concave surface 21a facing the bearing surface 11b, the sliding member 21 of the holder 12 is placed on the bearing surface 11b of the pedestal 11. Thus, the support member 22 is slidably supported on the pedestal 11 via the sliding member 21. This allows the support member 22 to tilt about the measurement point M as a center of tilting. Furthermore, the holding member 23 is placed on the support member 22. More specifically, in the holding member 23, the sliding contact part 26 is placed on the receiving seat 25a of the support part 25. Thus, the holding member 23 is supported on the support member 22 in a manner to be rotatable about the center of the reflector 13. In this manner, the measurement jig 2 is assembled, and thus the measurement jig 2 is mounted at the measurement point M.

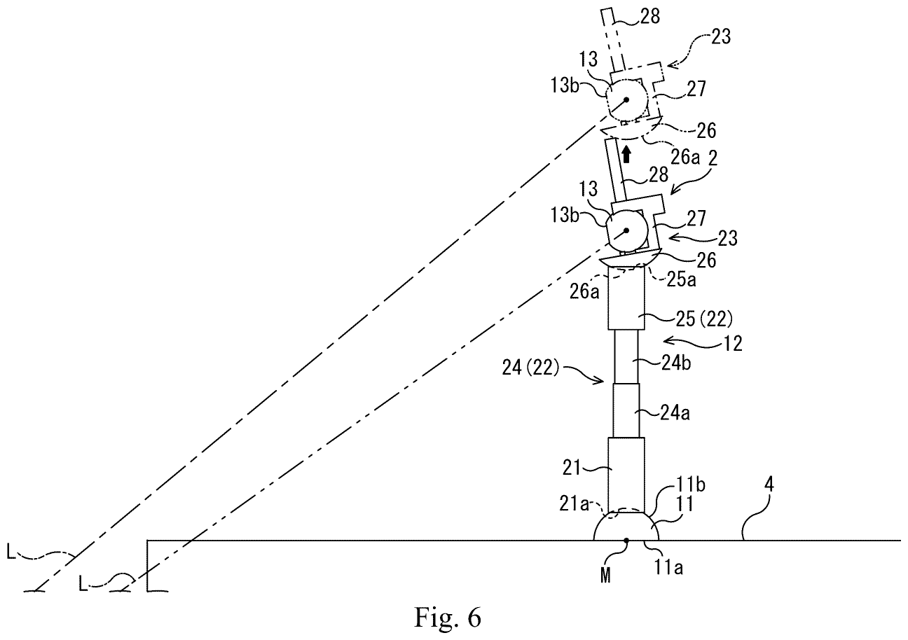

In the measurement jig 2, there are cases where the laser light L emitted from the three-dimensional measurement device 3 to the reflector 13 is blocked by a portion of the measurement subject 4, other obstacles, or the like, as indicated by the solid line in FIG. 6. In this case, in the measurement jig 2, the contraction part 24 of the support member 22 is expanded (refer to the dash-dot-dot line in FIG. 6). As a result, the position of the reflector 13 can be raised. This allows the laser light L to reach the reflector 13 without being blocked. Note that although not illustrated in the drawings, in the measurement jig 2, the contraction part 24 of the support member 22 can also be contracted to position the reflector 13 so that the laser light L avoids a portion of the measurement subject 4, other obstacles, and the like.

### <Measurement Method for Three-Dimensional Measurement System>

As illustrated in FIG. 1, in the three-dimensional measurement system 1, first, the measurement jig 2 is mounted at the measurement point M in the above-described method. The three-dimensional measurement device 3 is mounted at a position away from the measurement jig 2, for example, on the floor or the like. The three-dimensional measurement device 3 emits the laser light L while causing the measurement part 3a to rotate up and down and left and right. When the laser light L is emitted to the reflector 13 of the measurement jig 2 and enters the lens 13a, the reflected light is brought back to the three-dimensional measurement device 3. As a result, the three-dimensional measurement device 3 calculates the position of the center of the reflector 13 (hereinafter referred to as “the center position”) on the basis of the reflected light.

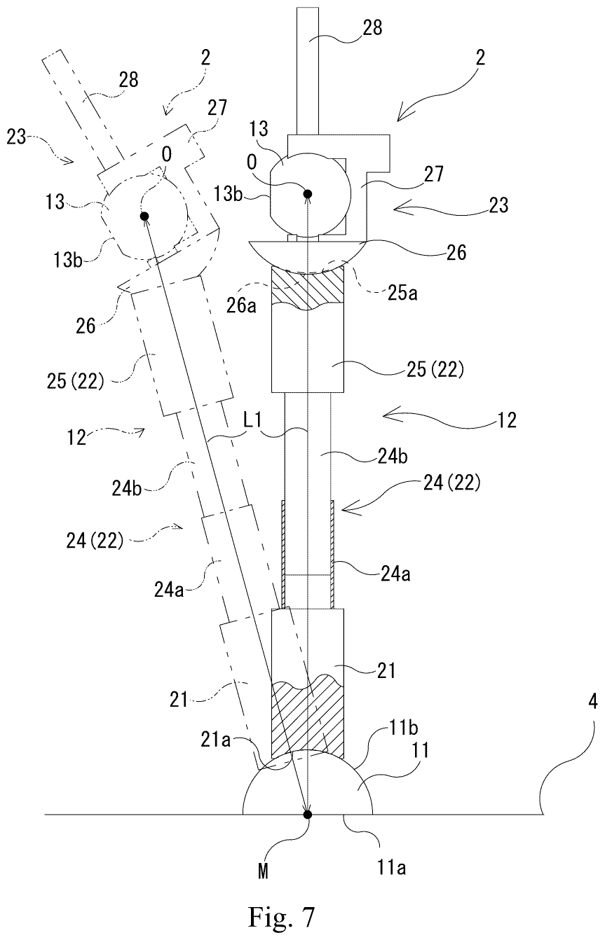

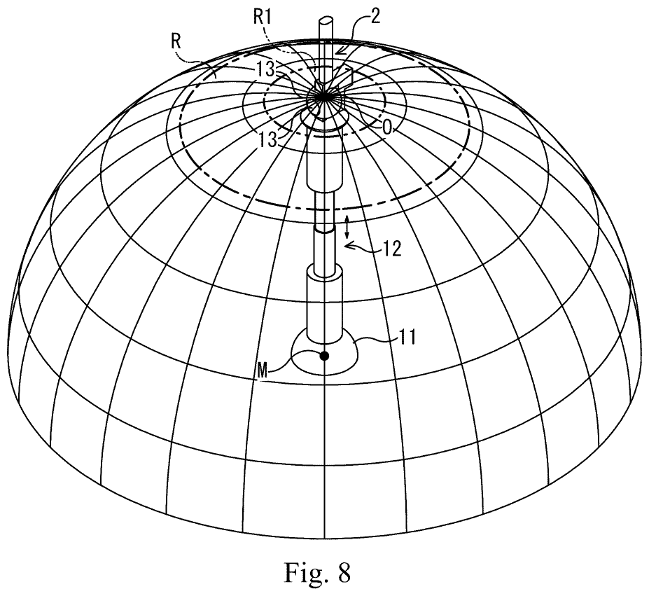

In the three-dimensional measurement system 1, a jig operator tilts the holder 12 of the measurement jig 2 about the measurement point M as the tilt fulcrum, as illustrated in FIG. 7 (refer to the dash-dot-dot line in FIG. 7). Thus, the three-dimensional measurement device 3 calculates the center position of the reflector 13 at more than one location. More specifically, the jig operator causes the holder 12 to slide on the pedestal 11 (specifically, the bearing surface 11b) in various directions while the three-dimensional measurement device 3 emits the laser light L, that is, during measurement. Thus, the holder 12 is tilted in various directions, at 360 degrees when viewed in plan. Accordingly, the reflector 13 is moved within a measurement range R indicated by the dash-dot line on a hemispherical surface in FIG. 8, for example. When a jig operator moves the reflector 13 within the measurement range R indicated by the dash-dot line during measurement, the three-dimensional measurement device 3 obtains the center position of the reflector 13 at more than one location within the measurement range R. The center position of the reflector 13 at more than one location is a position located on a hemispherical surface centered at the measurement point M (that is, the tilt fulcrum). Therefore, the three-dimensional measurement device 3 can calculate the position of the measurement point M on the basis of the center position of the reflector 13 at more than one location. In this manner, the three-dimensional measurement system 1 calculates the position of the measurement point M by operating the three-dimensional measurement device 3 and the measurement jig 2 in coordination.

Note that in the measurement jig 2, when the holder 12 is tilted, the orientation of the reflector 13, that is, the orientation of the lens 13a, changes according to a tilt angle. Therefore, in the holder 12, the holding member 23 is moved to slide on the support member 22 according to the tilt angle and is rotated about the center of the reflector 13 and thus, the orientation of the reflector 13 is changed. This allows the laser light L to be emitted to the lens 13a of the reflector 13 even when the holder 12 is tilted.

In the measurement jig 2 according to the present embodiment, the holder 12 includes the sliding member 21 that slides on the pedestal 11 while remaining centered at the tilt fulcrum. Therefore, when tilting the holder 12, the tilt fulcrum for the holder 12 is kept from becoming misaligned with the measurement point M, and the holder 12 can be tilted at a larger angle. Thus, it is possible to improve the accuracy of measuring the position of the measurement point M.

Furthermore, in the measurement jig 2 according to the present embodiment, the pedestal 11 includes the bearing surface 11b formed in the shape of a partial sphere centered at the tilt fulcrum. The sliding member 21 includes the concave surface 21a that has curvature equal to the curvature of the bearing surface 11b and comes into sliding contact with the bearing surface 11b. Therefore, it is possible to secure an area where the bearing surface 11b and the concave surface 21a come into sliding contact when the sliding member 21 slides on the bearing surface 11b. This allows the tilt fulcrum to be further kept from becoming misaligned with the measurement point M.

Furthermore, in the measurement jig 2 according to the present embodiment, the holding member 23 holds the reflector 13 in a manner to be rotatable about the center thereof. Therefore, it is possible to change the orientation of the reflector 13 without changing a distance L1 from the tilt fulcrum to a center O of the reflector 13 (that is, the distance from the measurement point M to the center O) (refer to FIG. 7). As a result, the holder 12 can be tilted at a larger angle during measurement. Specifically, the measurement range R of the measurement jig 2 can be wider than a measurement range R1 of a conventional measurement jig (refer to the measurement range R indicated by the dash-dot line and the measurement range R1 indicated by the dash-dot-dot line in FIG. 8), meaning that it is possible to further improve the accuracy of measuring the position of the measurement point M.

Furthermore, in the measurement jig 2 according to the present embodiment, the holding member 23 is provided on the support member 22 in a manner to be rotatable about the center of the reflector 13. Therefore, it is possible to change the orientation of the reflector 13 without changing the distance L1 from the tilt fulcrum to the center O of the reflector 13 (that is, the distance from the measurement point M to the center O). As a result, the holder 12 can be tilted at a larger angle during measurement. Specifically, the measurement range R of the measurement jig 2 can be wider than the measurement range R1 of a conventional measurement jig (refer to the measurement range R indicated by the dash-dot line and the measurement range R1 indicated by the dash-dot-dot line in FIG. 8), meaning that it is possible to further improve the accuracy of measuring the position of the measurement point M.

Furthermore, in the measurement jig 2 according to the present embodiment, the support member 22 expands and contracts in the predetermined direction. Therefore, it is possible to move the reflector 13 toward and away from the pedestal 11. Thus, when the laser light L is blocked by the measurement subject 4, other obstacles, or the like, it is possible to cause the support member 22 to expand and contract to move the reflector 13 to a zone where the laser light L reaches. This reduces the need to move the three-dimensional measurement device 3 during measurement so that the laser light L is emitted to the reflector 13.

Furthermore, in the measurement jig 2 according to the present embodiment, the pedestal 11 includes the through-hole 11c that passes through the tilt fulcrum and through which the pointing member 14 that points the measurement point M by being brought into contact with the measurement point M is inserted. Therefore, the tilt fulcrum can be accurately aligned with the measurement point M. Thus, it is possible to further improve the accuracy of measuring the position of the measurement point M.

Furthermore, in the measurement jig 2 according to the present embodiment, the pedestal 11 includes the suction part 11d that is attachable to and detachable from a portion around the measurement point M. Therefore, the pedestal 11 can be easily fixed to the measurement subject 4 after the pointing member 14 is placed at the measurement point M. This makes it possible to keep the pedestal 11 from becoming misaligned with the measurement point M when attaching the measurement subject 4 to the pedestal 11. Thus, it is possible to further improve the accuracy of measuring the position of the measurement point M.

With the three-dimensional measurement system 1 according to the present embodiment, it is possible to further improve the accuracy of measuring the position of the measurement point M.

### Embodiment 2

A three-dimensional measurement system 1A according to Embodiment 2 is similar in configuration to the three-dimensional measurement system 1 according to Embodiment 1. Therefore, the configuration of the three-dimensional measurement system 1A according to Embodiment 2 will be described focusing on differences from the three-dimensional measurement system 1 according to Embodiment 1; elements that are the same as those of the three-dimensional measurement system 1 according to Embodiment 1 share the same reference signs, and as such, description of the elements will be omitted.

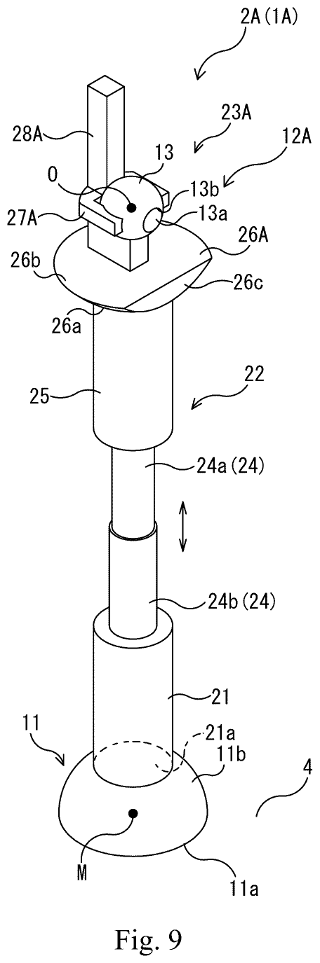

The three-dimensional measurement system 1A according to Embodiment 2 includes: the three-dimensional measurement device 3; and a measurement jig 2A illustrated in FIG. 9. The measurement jig 2A is also placed at the measurement point M. The measurement jig 2 includes the pedestal 11, a holder 12A, and the reflector 13. The holder 12A includes the sliding member 21, the support member 22, and a holding member 23A.

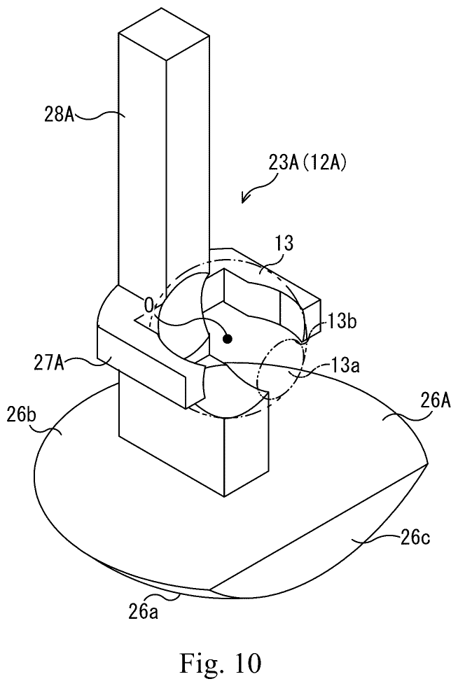

As illustrated in FIG. 10, the holding member 23A holds the reflector 13. The holding member 23A is provided on the support member 22 in a manner to be rotatable about the center of rotation (that is, the center of the reflector 13). The holding member 23A includes a sliding contact part 26A, a holding part 27A, and a grip part 28A.

The sliding contact part 26A is slidably supported on the support part 25 of the support member 22. The sliding contact part 26A includes the sliding contact surface 26a and the attachment surface 26b. Furthermore, the sliding contact part 26A is partially cut out. In other words, the sliding contact part 26A includes a cutout 26c. More specifically, more specifically, the sliding contact part 26A is cut out on one side in the first direction by a virtual plane perpendicular to the first direction. This means that the cutout 26c is formed on the sliding contact part 26A by cutting a bow shape, when viewed in plan, out of one side of the sliding contact part 26A in the first direction.

The holding part 27A is formed in the shape of the letter “C” when viewed in plan. This means that the holding part 27A is open on one side in the first direction when viewed in plan. The holding part 27A is formed in in the shape of the inverted letter “F” when viewed from the side. This means that the holding part 27A is formed so that a portion thereof on the sliding contact surface 26a side is bulky. The reflector 13 can fit into the holding part 27A so as to be surrounded on four sides, namely, on the sliding contact surface 26a side, on the other side in the first direction, and on both sides in a second direction. Note that the second direction is a direction perpendicular to the height direction and the first direction. Furthermore, since the portion on the sliding contact surface 26a side is formed to be bulky, the holding part 27A can position the reflector 13 apart from the sliding contact surface 26a. Moreover, the inner peripheral surface of the holding part 27A is depressed on the sliding contact surface 26a side, on the other side in the first direction, and on both sides in the second direction to match the shape of the reflector 13. This means that each of the inner peripheral surfaces of the holding part 27A on said four sides is partially depressed in the shape of a partial sphere. As a result, the reflector 13 can fit into the holding part 27A (more specifically, into the space surrounded by the inner peripheral surfaces). Furthermore, the holding part 27A having the reflector 13 fitted therein holds the reflector 13 positioned at a predetermined position (a position at which the center of rotation and the center of the reflector 13 match in the present embodiment). Accordingly, when the holding member 23A slides on the support member 22 (more specifically, the support part 25), the reflector 13 can rotate about the center thereof.

The grip part 28A is provided on the holding part 27A so as to be grippable. More specifically, the grip part 28A extends in the height direction from a portion of the holding part 27A that is located on the other side in the first direction. A jig operator can slide the holding member 23 on the receiving seat 25a of the support member 22 while pressing the holding member 23 against the receiving seat 25a by the grip part 28A.

In the three-dimensional measurement system 1A configured as just described, the measurement jig 2A is mounted at the measurement point M in substantially the same method as in the three-dimensional measurement system 1 according to Embodiment 1. Furthermore, in the three-dimensional measurement system 1A, the position of the measurement point M is measured by coordination of the three-dimensional measurement device 3 and the measurement jig 2A in substantially the same method as in the three-dimensional measurement system 1 according to Embodiment 1.

Furthermore, in the measurement jig 2A, the sliding contact part 26A includes the cutout 26c. Therefore, it is possible to reduce the likelihood of the lens 13a of the reflector 13 being overlaid on top of the sliding contact part 26A when rotating the reflector 13 toward the sliding contact part 26A within the holding part 27. For example, when the holder 12 is tilted on the other side in the first direction, the reflector 13 needs to rotate toward the sliding contact part 26A so that the laser light L is emitted to the lens 13a. In the measurement jig 2A, when the reflector 13 rotates toward the sliding contact part 26A, the lens 13a of the reflector 13 is less likely to be overlaid on top of the sliding contact part 26A and thus, the holder 12 can be tilted at a larger angle on the other side in the first direction.

Furthermore, in the measurement jig 2A, a portion of the holding part 27 that is located on the attachment surface 26b side is formed to be bulky. Therefore, it is possible to reduce the likelihood of the lens 13a of the reflector 13 being overlaid on top of the sliding contact part 26A when rotating the reflector 13 toward the sliding contact part 26A within the holding part 27. Therefore, in the measurement jig 2A, the holder 12 can be tilted at a larger angle on the other side in the first direction.

The three-dimensional measurement system 1A and the measurement jig 2A according to Embodiment 2 produces substantially the same advantageous effects as those produced by the three-dimensional measurement system 1 and the measurement jig 2 according to Embodiment 1.

### Other Embodiments

In the measurement jigs 2, 2A according to Embodiments 1, 2, the holders 12, 12A slide on the pedestal 11 and are thus tilted, but the holder 12 may be provided on the pedestal 11 using a universal joint or the like so as to be tiltable. Furthermore, the sliding member 21 does not necessarily need to include the concave surface 21a. For example, the sliding member 21 may include three protrusions at one end in the predetermined direction. When the sliding member 21 are supported at three points on the bearing surface 11b by the three protrusions, the sliding member 21 can slide along the bearing surface 11b. Therefore, the holder 12 can be tilted about the measurement point M as the tilt fulcrum even with the three protrusions.

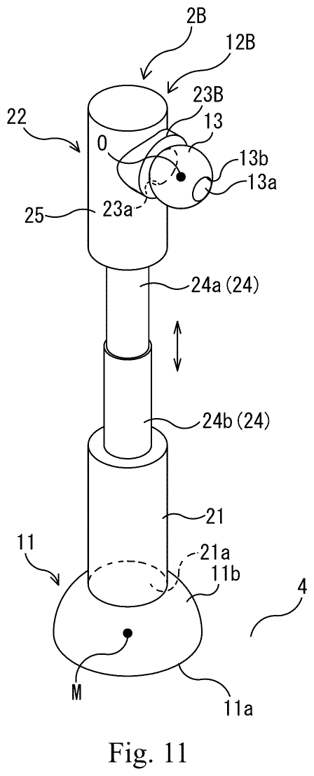

In the measurement jigs 2, 2A according to Embodiments 1, 2, the holding members 23, 23A are provided on the support member 22 (more specifically, the support part 25). However, in a holder 12B, a holding member 23B may be provided on a side surface of the support member 22 (more specifically, a side surface of the support part 25) as in a measurement jig 2B illustrated in FIG. 11. More specifically, the holding member 23B is a ring-shaped member including a permanent magnet. The holding member 23B is provided on a side surface of the support part 25 as mentioned above. The reflector 13 adheres to the holding member 23B with a spherical cap portion of the reflector 13 inserted in a center hole 23a of the holding member 23B. In the measurement jig 2B configured as just described, when the holder 12B is tilted about the measurement point M as the tilt fulcrum, the reflector 13 can be moved in a wide range as in the measurement jigs 2, 2A.

Furthermore, in the measurement jigs 2, 2A according to Embodiments 1, 2, the support member 22 expands and contracts in the predetermined direction, but the support member 22 does not necessarily need to expand and contract. Furthermore, the through-hole 11c is formed in the pedestal 11, but the through-hole 11c is not required to be formed. Moreover, the pedestal 11 is not required to include the suction part 11d.

### Exemplary Embodiments

A measurement jig according to the first aspect is a measurement jig that reflects laser light emitted from a three-dimensional measurement device and includes: a pedestal to be placed at a measurement point; a holder provided on the pedestal in a manner to be tiltable about the measurement point as a tilt fulcrum; and a reflector that is held by the holder and reflects the laser light emitted. The holder includes a sliding member that slides on the pedestal. The sliding member remains centered at the tilt fulcrum when sliding on the pedestal.

According to this aspect, the holder includes the sliding member that slides on the pedestal while remaining centered at the tilt fulcrum. Therefore, when tilting the holder, the tilt fulcrum for the holder is kept from becoming misaligned with the measurement point, and the holder can be tilted at a larger angle. Thus, it is possible to improve the accuracy of measuring the three-dimensional position of the measurement point.

In a measurement jig according to the second aspect, in the measurement jig according to the first aspect, the pedestal includes a bearing surface formed in the shape of a partial sphere centered at the tilt fulcrum, and the sliding member includes a concave surface that has curvature equal to curvature of the bearing surface and comes into sliding contact with the bearing surface.

According to this aspect, the pedestal includes the bearing surface formed in the shape of a partial sphere centered at the tilt fulcrum. Furthermore, the sliding member includes the concave surface that has curvature equal to the curvature of the bearing surface and comes into sliding contact with the bearing surface. Therefore, it is possible to secure an area where the bearing surface and the concave surface come into sliding contact when the sliding member slides on the bearing surface. This allows the tilt fulcrum to be further kept from becoming misaligned with the measurement point.

In a measurement jig according to the third aspect, in the measurement jig according to the second aspect, the holder holds the reflector in a manner to be rotatable about the center of the reflector.

According to this aspect, the holding member holds the reflector in a manner to be rotatable about the center of the reflector. Therefore, it is possible to change the orientation of the reflector without changing the distance from the tilt fulcrum to the center of the reflector (that is, the distance from the measurement point to the center of the reflector). As a result, the holder can be tilted at a larger angle during measurement. Thus, it is possible to further improve the accuracy of measuring the three-dimensional position of the measurement point.

In a measurement jig according to the fourth aspect, in the measurement jig according to any one of the first to third aspects, the holder includes: a support member extending in a predetermined direction; and a holding member that holds the reflector, the support member is provided on the pedestal in a manner to be tiltable about the tilt fulcrum, and the holding member is provided on the support member in a manner to be rotatable about the center of the reflector.

According to this aspect, the holding member is provided on the support member in a manner to be rotatable about the center of the reflector. Therefore, it is possible to change the orientation of the reflector without changing the distance from the tilt fulcrum to the center of the reflector (that is, the distance from the measurement point to the center of the reflector). As a result, the holder can be tilted at a larger angle during measurement. Thus, it is possible to further improve the accuracy of measuring the three-dimensional position of the measurement point.

In a measurement jig according to the fifth aspect, in the measurement jig according to the fourth aspect, the support member expands and contracts in the predetermined direction.

According to this aspect, the support member expands and contracts in the predetermined direction. Therefore, it is possible to move the reflector toward and away from the pedestal. Thus, when the laser light is blocked by a measurement subject, other obstacles, or the like, it is possible to cause the support member to expand and contract to move the reflector to a zone where the laser light reaches. This reduces the need to move the three-dimensional measurement device 3 during measurement.

In a measurement jig according to the sixth aspect, in the measurement jig according to any one of the first to fifth aspects, the pedestal includes a through-hole that extends through the pedestal so as to pass through the tilt fulcrum and through which a pointing member that points the measurement point by being brought into contact with the measurement point is inserted.

According to this aspect, the pedestal includes the through-hole that passes through the tilt fulcrum and through which the pointing member that points the measurement point by being brought into contact with the measurement point is inserted. Therefore, the tilt fulcrum can be accurately aligned with the measurement point. Thus, it is possible to further improve the accuracy of measuring the three-dimensional position of the measurement point.

In a measurement jig according to the seventh aspect, in the measurement jig according to the sixth aspect, the pedestal includes a suction part that is attachable to and detachable from a portion around the measurement point.

According to this aspect, the pedestal includes the suction part that is attachable to and detachable from a portion around the measurement point. Therefore, the pedestal can be easily fixed to the measurement subject after the pointing member is pressed against the measurement point. Thus, it is possible to keep the pedestal from being placed on the measurement subject in the state where the measurement point is misaligned with the tilt fulcrum. Thus, it is possible to further improve the accuracy of measuring the three-dimensional position of the measurement point.

A three-dimensional measurement system according to the eighth aspect includes: the measurement jig according to any one of the first to seventh aspects; and the three-dimensional measurement device that emits laser light and measures a three-dimensional position of the measurement point on the basis of the laser light reflected by the measurement jig.

According to this aspect, it is possible to further improve the accuracy of measuring the three-dimensional position of the measurement point.

From the foregoing description, many modifications and other embodiments of the present invention would be obvious to a person having ordinary skill in the art. Therefore, the foregoing description should be interpreted only as an example and is provided for the purpose of teaching the best mode for carrying out the present invention to a person having ordinary skill in the art. Substantial changes in details of the structures and/or functions of the present invention are possible within the spirit of the present invention.

1. A measurement jig that reflects laser light emitted from a three-dimensional measurement device, the measurement jig comprising:
a pedestal to be placed at a measurement point;
a holder provided on the pedestal in a manner to be tiltable about the measurement point as a tilt fulcrum; and
a reflector that is held by the holder and reflects the laser light emitted, wherein:
the holder includes a sliding member that slides on the pedestal; and
the sliding member remains centered at the tilt fulcrum when sliding on the pedestal.

2. The measurement jig according to claim 1, wherein:
the pedestal includes a bearing surface formed in the shape of a partial sphere centered at the tilt fulcrum; and
the sliding member includes a concave surface that has curvature equal to curvature of the bearing surface and comes into sliding contact with the bearing surface.

3. The measurement jig according to claim 1, wherein:
the holder holds the reflector in a manner to be rotatable about the center of the reflector.

4. The measurement jig according to claim 1, wherein:
the holder includes: a support member extending in a predetermined direction; and a holding member that holds the reflector;
the support member is provided on the pedestal in a manner to be tiltable about the tilt fulcrum; and
the holding member is provided on the support member in a manner to be rotatable about the center of the reflector.

5. The measurement jig according to claim 4, wherein:
the support member expands and contracts in the predetermined direction.

6. The measurement jig according to claim 1, wherein:
the pedestal includes a through-hole that extends through the pedestal so as to pass through the tilt fulcrum and through which a pointing member that points the measurement point by being brought into contact with the measurement point is inserted.

7. The measurement jig according to claim 6, wherein:
the pedestal includes a suction part that is attachable to and detachable from a portion around the measurement point.

8. A three-dimensional measurement system comprising:
the measurement jig according to claim 1; and
the three-dimensional measurement device that emits laser light and measures a three-dimensional position of the measurement point on the basis of the laser light reflected by the measurement jig.
